(19) United States
(12) Patent Application Publication
(10) Pub. No.: US 2015/0215034 A1
(43) Pub. Date: Jul. 30, 2015

(54) PON SYSTEM AND OLT

(71) Applicants: Genya KOTANI, Tokyo (JP); MITSUBISHI ELECTRIC CORPORATION, Tokyo (JP)

(72) Inventor: Genya Kotani, Chiyoda-ku (JP)

(73) Assignee: Mitsubishi Electric Corporation, Chiyoda-ku Tokyo (JP)

(21) Appl. No.: 14/430,061

(22) PCT Filed: Dec. 21, 2012
(86) PCT No.: PCT/JP12/83306

§ 371 Date: Mar. 20, 2015

(51) Int. Cl. H04B 10/038

(52) U.S. Cl. CPC H04B 10/038

(57) ABSTRACT

An OLT includes a topology map holder that holds a topology map of a PON system, a link interruption detector that detects a link interruption of an ONU, a warning collector that collects warnings from an ONU, a filter that extracts a warning resulting from an ONU from the warnings collected by the warning collector, a fault part estimator that, when a link interruption of an ONU is detected by the link interruption detector and there is no warning which is extracted by the filter, estimates in which of optical fiber cables a fault has occurred on the basis of the topology map held by the topology map holder, and a fault part notifier that notifies information showing the fault part estimated by the fault part estimator to outside the OLT.

### FIELD OF THE INVENTION

The present invention relates to a PON (Passive Optical Network) system and an OLT in this PON system that estimate an optical fiber cable in which a fault has occurred at the time when a link interruption occurs in an ONU (Optical Network Unit), and notify this estimation, as a warning, to an outside (OpS: Operation System) of the PON system.

### BACKGROUND OF THE INVENTION

As optical broadband services have become widespread, the number of installations of GE-PON (Gigabit Ethernet-Passive Optical Network (Ethernet is a registered trademark)) ONU in ordinary homes has also increased. Further, in future, the case in which a PON system is applied even in the network construction of a smart grid system also increases. Therefore, a maintenance service of a network which has become gigantic is one of important issues. Especially when the connection with an ONU happens to be broken, because this disconnection immediately affects the user and results in a claim, immediate pinpointing of the fault part and recovery are needed.

As a conventional technology of pinpointing this fault part, a method of pinpointing a section in which the fault has occurred by detecting the number of frame error occurrences in both upward and downward directions is known (for example, refer to patent reference 1).

### RELATED ART DOCUMENT

### Patent Reference

Patent reference 1: Japanese Unexamined Patent Application Publication No. 2007-166446

### SUMMARY OF THE INVENTION

### Problems To Be Solved by the Invention

However, in the technique as disclosed in patent reference 1, every time when a change, such as an extension of a splitter, an optical fiber, or an ONU, is made to the topology map, a threshold for determining whether or not the number of frame errors occurring is unusual must be changed. A problem is therefore that the technique is unsuitable for a system in which the number of users varies greatly.

A further problem with the PON system is that an optical fiber cable itself including a splitter does not have a function of detecting a fault directly, and therefore the PON system cannot directly detect in which position of an extended fiber a fault has occurred.

The present invention is made in order to solve the above-mentioned problems, and it is therefore an object of the present invention to provide a PON system and an OLT that do not need to newly make a change to parameters and so on even if the topology map of the PON system is changed, and that can notify in which optical fiber cable a fault has occurred at the time of occurrence of a link interruption in an ONU to outside the PON system and the OLT.

### Means for Solving the Problem

In accordance with the present invention, there is provided a PON system including an OLT connected to a plurality of ONUs via a plurality of splitters and optical fiber cables, in which the OLT includes: a topology map holder that holds a topology map of the PON system; a link interruption detector that detects a link interruption of the ONUs; a warning collector that collects warnings from the ONUs; a filter that extracts a warning resulting from the ONUs from the warnings collected by the warning collector; a fault part estimator that, when a link interruption of the ONUs is detected by the link interruption detector and there is no warning which is extracted by the filter, estimates in which of the optical fiber cables a fault has occurred on the basis of the topology map held by the topology map holder; and a fault part notifier that notifies information showing the fault part estimated by the fault part estimator to outside the PON system.

### Advantages of the Invention

Because the PON system in accordance with the present invention is configured as above, the PON system does not need to newly make a change to parameters and so on even if the topology map of the PON system is changed, and can notify in which optical fiber cable a fault has occurred at the time of occurrence of a link interruption in an ONU to outside the PON system.

### BRIEF DESCRIPTION OF THE FIGURES

FIG. 1 is a block diagram showing the configuration of transmission lines of a PON system in accordance with Embodiment 1 of the present invention;

FIG. 2 is a table showing the configuration of the transmission lines of the PON system in accordance with Embodiment 1 of the present invention;

FIG. 3 is a block diagram showing the structure of an OLT in accordance with Embodiment 1 of the present invention;

FIG. 4 is a flow chart showing the operation of the OLT in accordance with Embodiment 1 of the present invention;

FIG. 5 is a table showing an example of determination of apart at which a fault has occurred when a link interruption occurs in an ONU in the PON system in accordance with Embodiment 1 of the present invention;

FIG. 6 is a block diagram showing the structure of an OLT in accordance with Embodiment 2 of the present invention;

FIG. 7 is a block diagram showing the configuration of transmission lines of a PON system in accordance with Embodiment 2 of the present invention;

FIG. 8 is a flow chart showing the operation of an ONU in accordance with Embodiment 2 of the present invention;

FIG. 9 is a block diagram showing the configuration of transmission lines of a PON system in accordance with Embodiment 3 of the present invention; and

FIG. 10 is a block diagram showing the structure of an OLT in accordance with Embodiment 3 of the present invention.

### EMBODIMENTS OF THE INVENTION

Hereafter, the preferred embodiments of the present invention will be explained in detail with reference to the drawings.

### Embodiment 1

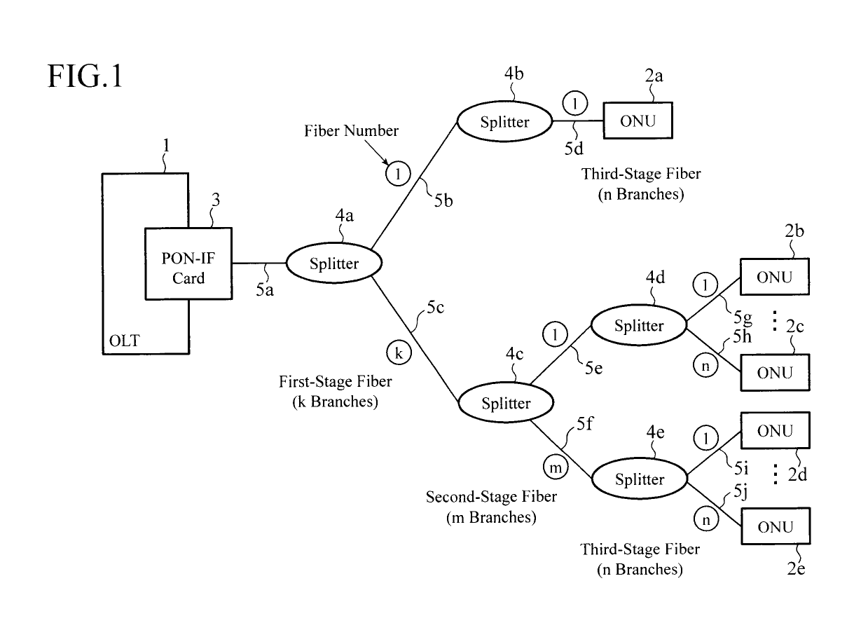

FIG. 1 is a block diagram showing the configuration of transmission lines of a PON system in accordance with the present invention, and is a diagram showing the branch structure of optical fiber cables 5a to 5j extending from one PON port of an OLT 1 to ONUs 2a to 2e.

The PON system is comprised of the OLT 1 and the plurality of ONUs 2a to 2e each placed in a user's house, as shown in FIG. 1. Further, a PON-IF card 3 is disposed in the OLT 1, and the optical fiber cable 5a is connected to one PON port of this PON-IF card. The OLT 1 and the ONUs 2a to 2e are connected to each other via a plurality of splitters 4a to 4e and the optical fiber cables 5a to 5j.

In the example shown in FIG. 1, the optical fiber cable 5a connected to the PON-IF card 3 is branched into k fiber cables by the splitter 4a, and the optical fiber cable 5b having a fiber number of 1, among these fiber cables, is connected to the splitter 4b and the optical fiber cable 5c having a fiber number of k is connected to the splitter 4c.

Further, no further branch is performed by the splitter 4b and the optical fiber cable 5d is connected to the ONU 2a. On the other hand, a further branch into m fiber cables is performed by the splitter 4c, and the optical fiber cable 5e having a fiber number of 1, among these fiber cables, is connected to the splitter 4d and the optical fiber cable 5f having a fiber number of m is connected to the splitter 4e.

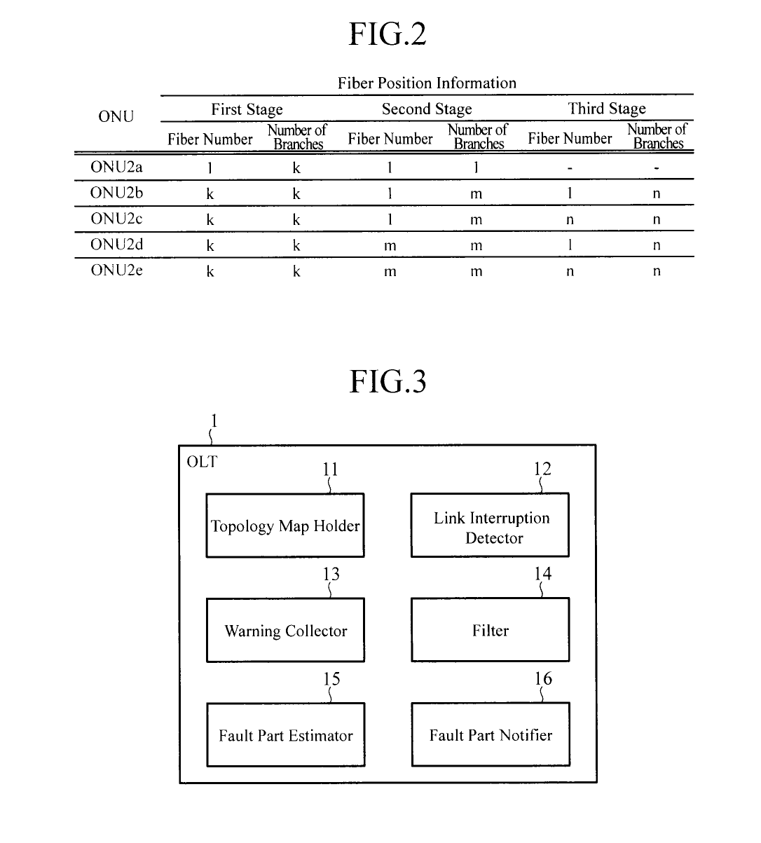

Further, a further branch into n fiber cables is performed by the splitter 4d, and the optical fiber cable 5g having a fiber number of 1 is connected to the ONU 2b and the optical fiber cable 5h having a fiber number of n is connected to the ONU 2c. On the other hand, a further branch into n fiber cables is also performed by the splitter 4e, and the optical fiber cable 5i having a fiber number of 1 is connected to the ONU 2d and the optical fiber cable 5j having a fiber number of n is connected to the ONU 2e. FIG. 2 is a table showing the configuration of the transmission lines of FIG. 1 (a topology map).

When it is not necessary to particularly make a distinction hereafter, one of the ONUs 2a to 2e, one of the splitters 4a to 4e, and one of the optical fiber cables 5a to 5j are referred to as an ONU 2, a splitter 4, and an optical fiber cable 5, respectively.

Next, the internal structure of the OLT 1 will be explained with reference to FIG. 3.

The OLT 1 is comprised of a topology map holder 11, a link interruption detector 12, a warning collector 13, a filter 14, a fault part estimator 15, and a fault part notifier 16, as shown in FIG. 3.

The topology map holder 11 holds the topology map of the PON system. More specifically, the topology map holder 11 holds the topology map as shown in, for example, FIG. 2.

The link interruption detector 12 detects a link interruption of an ONU 2 in the PON system.

The warning collector 13 collects warnings notified thereto from an ONU 2 in the PON system.

The filter 14 extracts only a warning which results from the ONU 2 (e.g., a warning which makes it possible to pinpoint the cause of the link interruption, such as power-down or an optical receive level reduction) from the warnings collected by the warning collector 13, and removes the other warnings.

When a link interruption of an ONU 2 is detected by the link interruption detector 12, and no warning has been extracted by the filter 14, the fault part estimator 15 estimates in which optical fiber cable 5 in the PON system a fault has occurred on the basis of the topology map held by the topology map holder 11.

The fault part notifier 16 notifies information showing the fault part estimated by the fault part estimator 15 to outside the PON system (to a not-shown OpS).

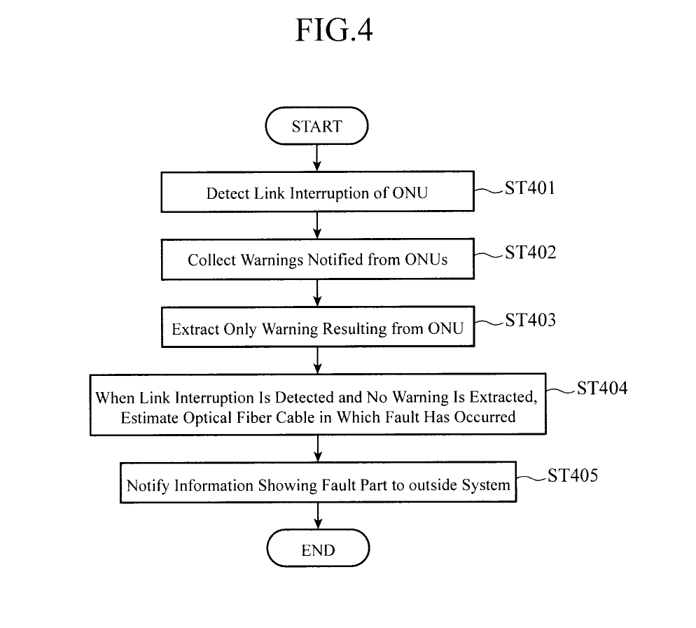

Next, the operation of the OLT 1 configured as above will be explained with reference to FIG. 4. The topology map holder 11 holds the topology map of the PON system as shown in FIG. 2 in advance.

In the operation of the OLT 1, as shown in FIG. 4, the link interruption detector 12 detects a link interruption of an ONU 2 in the PON system first (step ST401).

Further, the warning collector 13 collects warnings notified thereto from the ONU 2 in the PON system (step ST402).

The filter 14 then extracts only a warning which results from the ONU 2 (e.g., power-down or the like) from the warnings collected by the warning collector 13, and removes the other warnings (step ST403).

Then, when a link interruption of an ONU 2 is detected by the link interruption detector 12, and no warning has been extracted by the filter 14, the fault part estimator 15 estimates in which optical fiber cable 5 in the PON system a fault has occurred on the basis of the topology map held by the topology map holder 11 (step ST404).

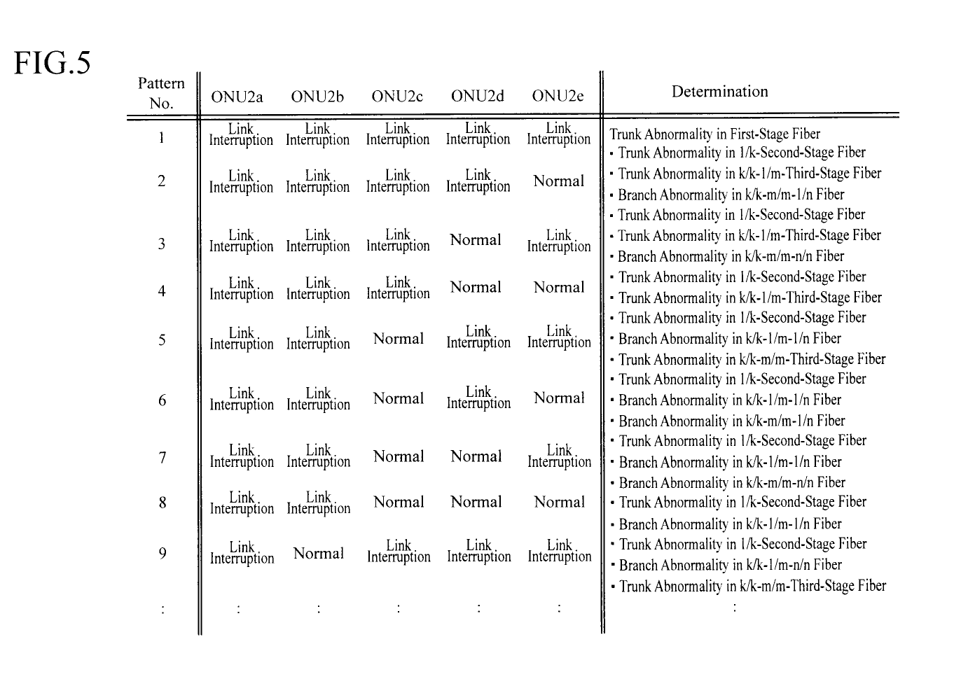

In this embodiment, the fault part estimator 15 holds a decision table as shown in, for example, FIG. 5 in advance. FIG. 5 shows the decision table with which to determine in which of the optical fiber cables 5a to 5j a fault has occurred by determining in which ONU 2 of the ONUs 2a to 2e a link interruption has occurred.

In FIG. 5, for example, a pattern No. 1 shows a case in which a link interruption has occurred in all the ONUs 2a to 2e. In this case, when no warnings resulting from the ONUs 2a to 2e themselves are notified, the fault part estimator 15 determines that a trunk fault has occurred in the optical fiber cable 5a in a first stage.

Further, for example, a pattern No. 5 shows a case in which only the ONU 2c links up normally and a link interruption has occurred in all the other ONUs 2. In this case, the fault part estimator 15 determines that a trunk fault has occurred in the optical fiber cable 5b, a branch fault has occurred in the optical fiber cable 5g, and a trunk fault has occurred in the optical fiber cable 5f. Although in this case, it can be determined that the link interruption occurring in the ONU 2a results from a branch fault in the optical fiber cable 5d, it is determined that a trunk fault has occurred in the optical fiber cable 5b as a fault in a higher level.

The fault part notifier 16 then notifies information showing the fault part estimated by the fault part estimator 15 to outside the OLT (step ST405).

Through the above-mentioned operation, the OLT can estimate a fault part (a trunk fault or a branch fault) of an optical fiber cable 5 connected to the PON-IF card 3 from a link interruption of an ONU 2, can cause the OpS to display the fault part.

As mentioned above, the OLT in accordance with this Embodiment 1 is configured to, when a link interruption of an ONU 2 is detected by the link interruption detector 12, and no warning has been extracted by the filter 14, estimate in which optical fiber cable 5 a fault has occurred on the basis of the topology map held by the topology map holder 11, the OLT does not need to newly make a change to the parameters and so on even if the topology map of the PON system is changed, and can notify in which optical fiber cable 5 a fault has occurred at the time of occurrence of a link interruption in an ONU to outside the OLT.

### Embodiment 2

In accordance with Embodiment 1, the OLT can estimate in which optical fiber cable 5 a fault (a trunk fault or a branch fault) has occurred at the time of occurrence of a link interruption in an ONU 2. However, when an ONU 2 itself breaks down and enters a state in which it cannot report a fault occurring in the ONU 2, it is impossible to make a distinction whether the link interruption of the ONU 2 results from either a fault of an optical fiber cable 5 or a fault of the ONU 2. To solve this problem, in accordance with Embodiment 2, a method of, when such a state as above occurs, determining whether the state results from either a fault of an optical fiber cable 5 or a fault of an ONU 2 will be shown.

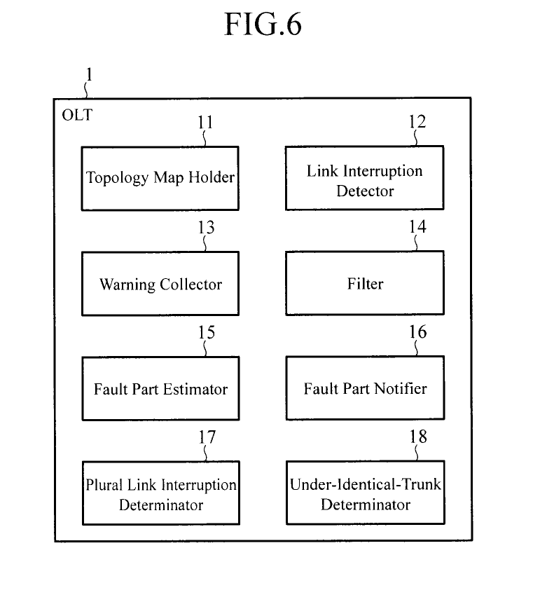

FIG. 6 is a block diagram showing the structure of an OLT 1 in accordance with Embodiment 2 of the present invention. The OLT 1 in accordance with Embodiment 2 shown in FIG. 6 includes a plural link interruption determinator 17 and an under-identical-trunk determinator 18 in addition to the components of the OLT 1 in accordance with Embodiment 1 shown in FIG. 3. The other structural components are the same as those of the OLT in accordance with Embodiment 1 and are designated by the same reference numerals, and only different portions will be explained hereafter.

The plural link interruption determinator 17 determines whether or not link interruptions have been detected in a plurality of ONUs 2 within a predetermined time period by a link interruption detector 12.

When the plural link interruption determinator 17 determines that link interruptions have been detected in a plurality of ONUs 2 within the predetermined time period, the under-identical-trunk determinator 18 determines whether link interruptions have occurred in all the ONUs 2 serving under an identical optical fiber cable 5 on the basis of a topology map held by a topology map holder 11.

A fault part estimator 15 determines whether a link interruption of an ONU 2 results from either a fault of an optical fiber cable 5 or a fault of the ONU 2 on the basis of results of the determinations performed by the plural link interruption determinator 17 and the under-identical-trunk determinator 18.

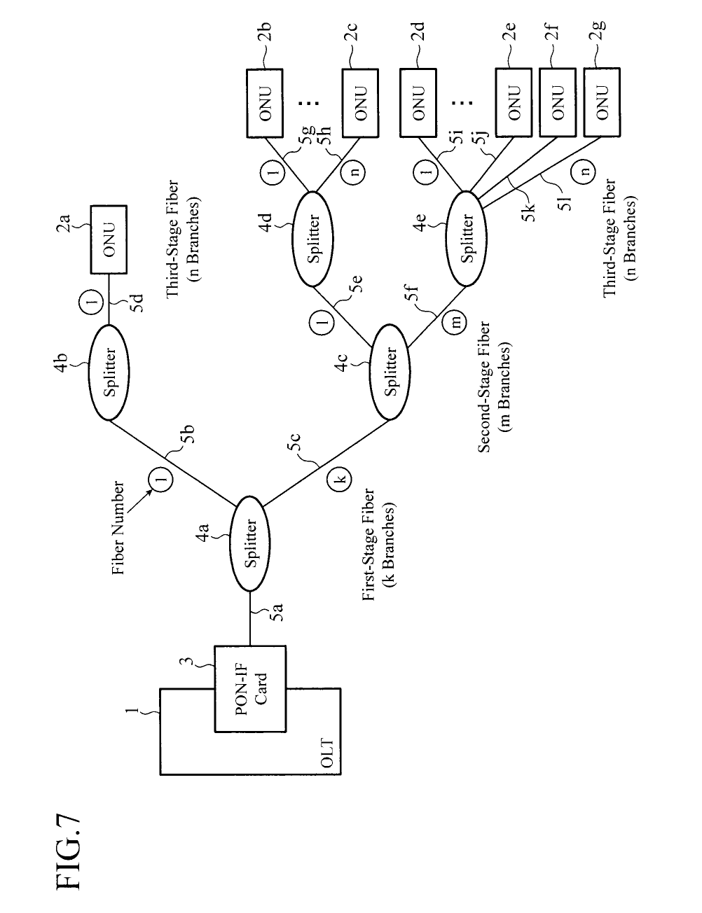

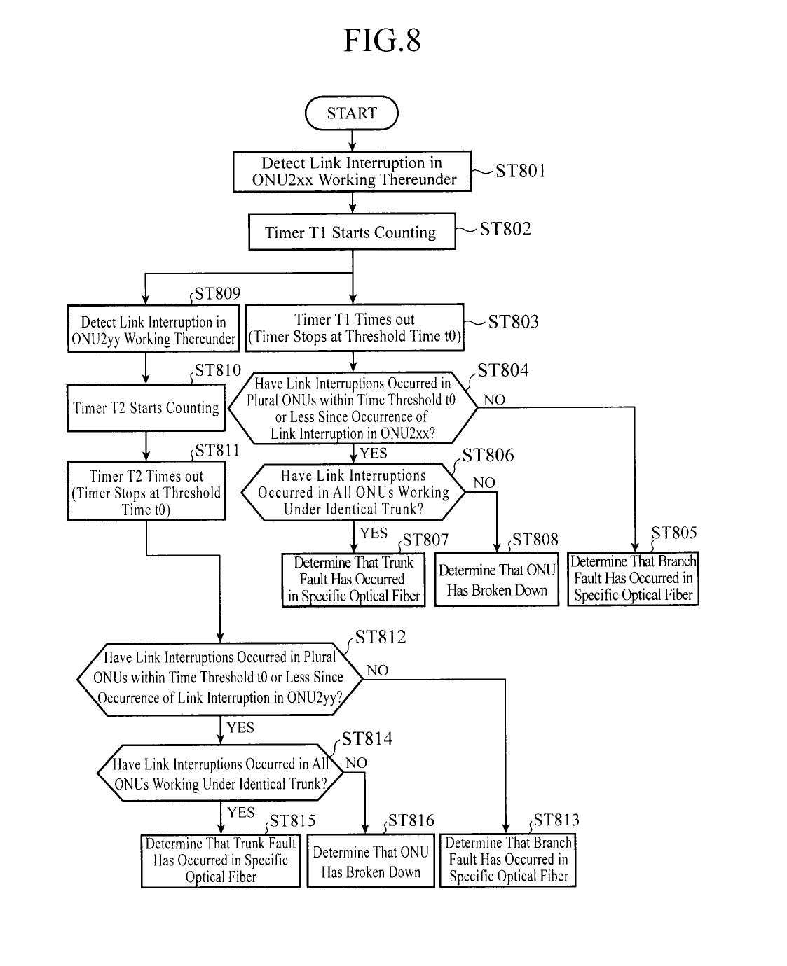

Next, the operation of the OLT 1 configured as above will be explained with reference to FIGS. 7 and 8.

When a link interruption is detected in either one of, for example, ONUs 2d to 2g shown in FIG. 7 (in FIG. 8, an ONU 2xx) by a link interruption detector 12 (step ST801), the OLT 1 in accordance with Embodiment 2 is triggered by this detection and starts a timer T1 (step ST802), as shown in FIG. 8. This timer T1 stops when it reaches a time threshold to preset as a parameter (step ST803). The plural link interruption determinator 17 then checks whether link interruptions have occurred between the OLT and a plurality of ONUs 2 within this time threshold t0 on the basis of a record of fault occurrences (step ST804).

When the plural link interruption determinator 17, in this step ST804, determines that link interruptions have not occurred in a plurality of ONUs 2 within the time threshold t0, the fault part estimator 15 determines that a branch fault has occurred in a specific optical fiber cable 5 (step ST805).

In contrast, when the plural link interruption determinator 17, in step ST804, determines that link interruptions have occurred in a plurality of ONUs 2 within the time threshold t0, the under-identical-trunk determinator 18 checks whether those link interruptions have occurred in all the ONUs 2d to 2g serving under a certain specific optical fiber cable 5f (step ST806).

When the under-identical-trunk determinator 18, in this step ST806, determines that the link interruptions have occurred in all the ONUs 2d to 2g serving under the identical optical fiber cable 5f, the fault part estimator 15 determines that a trunk fault has occurred in the optical fiber cable 5f (step ST807).

In contrast, when the under-identical-trunk determinator 18, in step ST806, determines that the link interruptions have not occurred in all the ONUs 2d to 2g serving under the identical optical fiber cable 5f, the fault part estimator 15 determines that a fault has occurred in the ONU 2 in which the link interruption has occurred (step ST808).

The OLT 1 is provided with a plurality of timers, and, when a link interruption occurs between the OLT and the above-mentioned ONU 2 (the ONU 2xx in FIG. 8), and a link interruption is then detected between the OLT and a different ONU 2 (an ONU 2yy in FIG. 8) while the timer T1 is active (step ST809), the OLT is triggered by this detection and starts a timer T2 (step ST810). After that, according to the same flow as that shown above, the OLT determines whether either a fault has occurred in a specific optical fiber cable 5 or a fault has occurred in a specific ONU 2 (steps ST811 to ST816).

As mentioned above, the OLT in accordance with this Embodiment 2 is configured in such a way that it determines whether link interruptions have been detected in a plurality of ONUs 2 within a predetermined time period by the link interruption detector 12 by using the plural link interruption determinator 17, and, when the plural link interruption determinator 17 determines that link interruptions have been detected in a plurality of ONUs 2 within the predetermined time period, determines whether the link interruptions have occurred in all the ONUs 2 serving under an identical optical fiber cable 5 on the basis of the topology map held by the topology map holder 11 by using the under-identical-trunk determinator 18, and the fault part estimator 15 determines whether a link interruption occurring in an ONU 2 results from a fault of an optical fiber cable 5 or a fault of the above-mentioned ONU 2 on the basis of results of these determinations. Therefore, there is provided an advantage of, when a link interruption occurs in an ONU 2, being able to notify not only a warning assuming a fault of an optical fiber cable 5 but also a warning assuming a fault of the ONU 2 to outside the OLT, in addition to the advantage provided by Embodiment 1.

### Embodiment 3

In Embodiments 1 and 2, when the cause of a link interruption occurring in an ONU 2 is determined to be a fault of an optical fiber cable 5, whether this fault results from either a cable fault, such as a disconnection of the optical fiber cable 5, or a fault of a splitter 4 cannot be identified. To solve this problem, in accordance with Embodiment 3, a method of determining whether the fault results from either a fault of an optical fiber cable 5 or a fault of a splitter 4 will be shown.

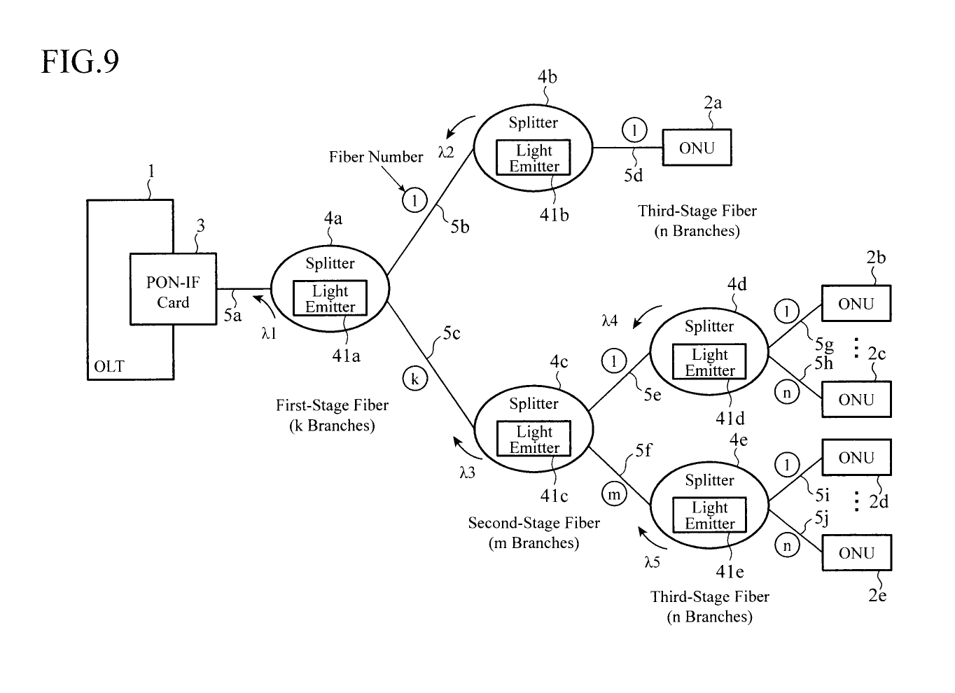

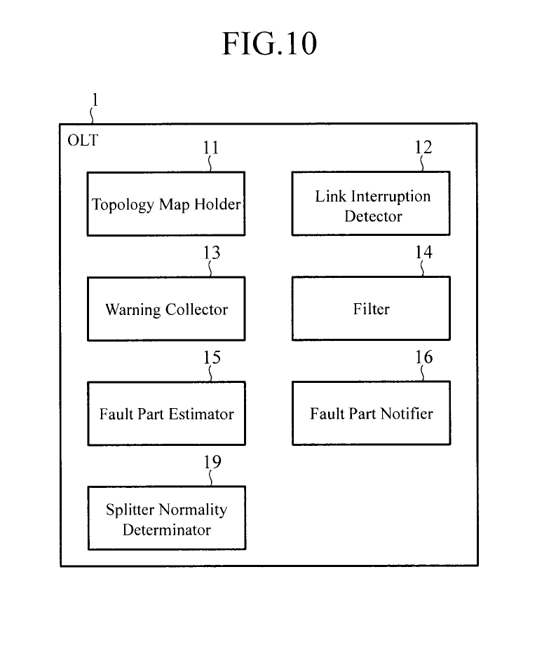

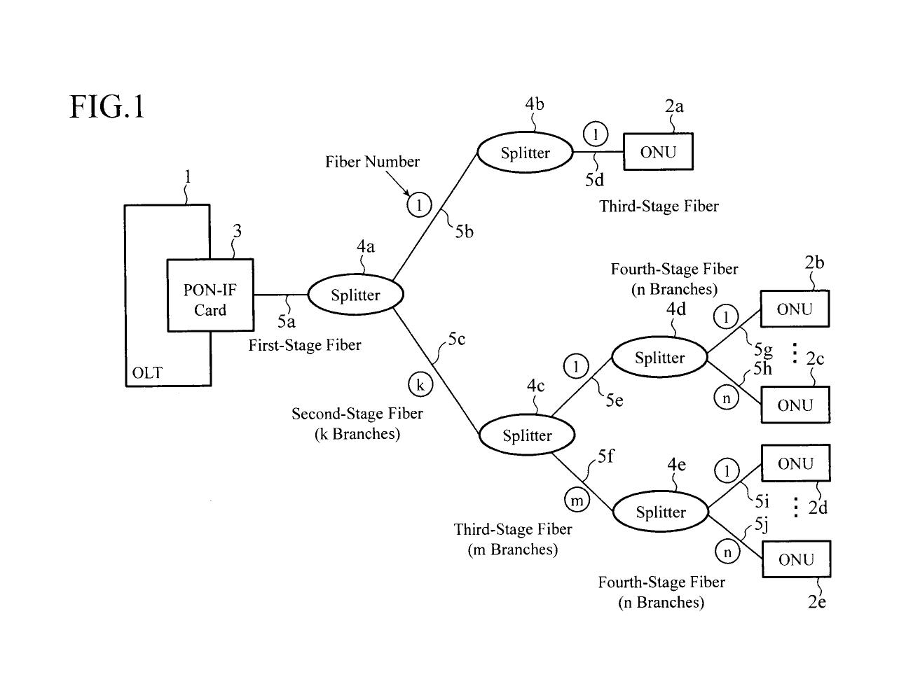

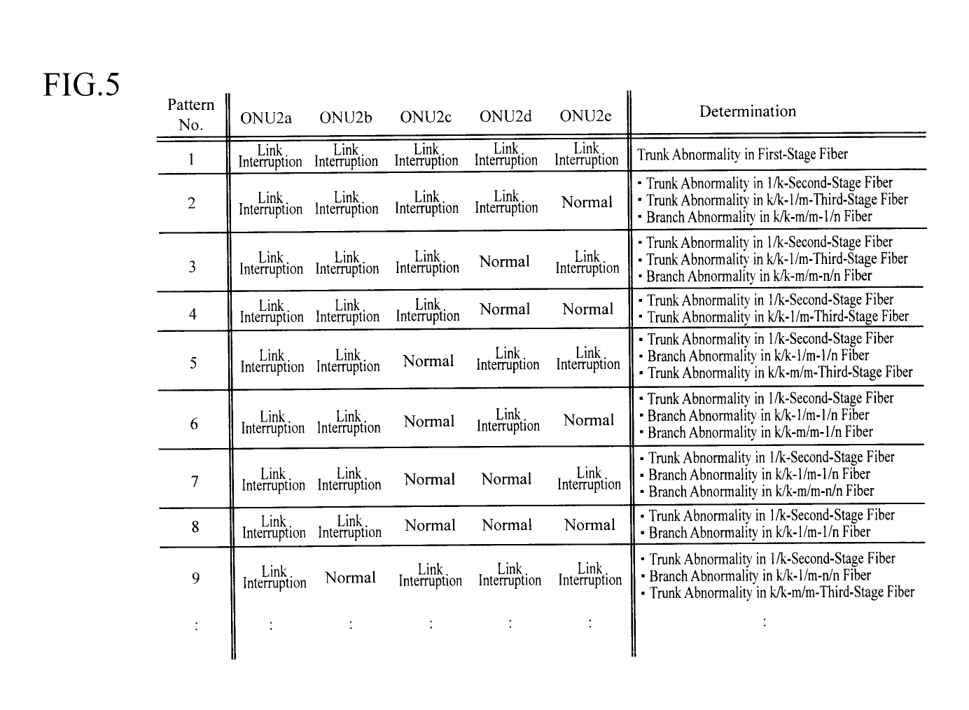

FIG. 9 is a block diagram showing the configuration of transmission lines of a PON system in accordance with Embodiment 3 of the present invention, and FIG. 10 is a block diagram showing the structure of an OLT 1 in accordance with Embodiment 3 of the present invention. In the PON system in accordance with Embodiment 3 shown in this FIG. 9, light emitters 41a to 41e are added to the splitters 4a to 4e of the PON in accordance with Embodiment 1 shown in FIG. 1, respectively. When it is not necessary to particularly make a distinction hereafter, one of the light emitters 41a to 41e is referred to as a light emitter 41. Further, the OLT1 in accordance with Embodiment 3 shown in FIG. 10 includes a splitter normality determinator 19 in addition to the components of the OLT 1 in accordance with Embodiment 1 shown in FIG. 3. The other structural components are the same as those of the OLT in accordance with Embodiment 1 and are designated by the same reference numerals, and only different portions will be explained hereafter.

A light emitter 41 is disposed in each splitter 4, and instantaneously emits light having a different wavelength toward the OLT 1 at predetermined intervals.

The splitter normality determinator 19 is disposed in the OLT 1, and detects the light emitted by the light emitter 41 and performs determination of whether or not each splitter 4 is normal.

A fault part estimator 15 determines whether a link interruption of an ONU 2 results from either a fault of a portion extending from a splitter 4 to the OLT 1 or a fault of a portion extending from the splitter 4 to the ONU 2 on the basis of a result of the determination performed by the splitter normality determinator 19.

Next, the operation of the PON system configured as above will be explained with reference to FIG. 9.

The splitter normality determinator 19 of the OLT 1 receives the light from the light emitter 41 of each splitter 4 and, when being able to receive this light at regular intervals, determines that this splitter 4 is normal. In contrast, when being unable to receive the light from the light emitter 41 of a splitter 4 during a fixed time period or longer, the splitter normality determinator determines that the splitter 4 has broken down.

Therefore, if the light having a wavelength lambda5 from the splitter 4e can be received when, for example, link interruptions have occurred in an ONU 2d and an ONU 2e in FIG. 9, it can be determined that the splitter 4e and an optical fiber cable 5f are normal, and a fault has occurred in either of an optical fiber cable 5i and the ONU 2d and a fault has occurred in either of an optical fiber cable 5j and the ONU 2e. In contrast, when the light having a wavelength lambda5 from the splitter 4e cannot be received, it can be determined that the splitter 4e has broken down or a fault has occurred in the optical fiber cable 5f.

As mentioned above, the PON system in accordance with this Embodiment 3 is configured in such a way that the light emitter 41 that emits light having a different wavelength toward the OLT 1 is disposed in each splitter 4, the splitter normality determinator 19 of the OLT 1 detects the light emitted by the light emitter 41 and performs determination of whether or not each splitter 4 is normal, and the fault part estimator 15 determines whether a link interruption of an ONU 2 results from either a fault of a portion extending from a splitter 4 to the OLT 1 or a fault of a portion extending from the splitter 4 to the ONU 2 on the basis of a result of the determination performed by the splitter normality determinator 19. Therefore, the PON system can estimate a fault part more finely as compared with Embodiments 1 and 2.

While the invention has been described in its preferred embodiments, it is to be understood that an arbitrary combination of two or more of the above-mentioned embodiments can be made, various changes can be made in an arbitrary component in accordance with any one of the above-mentioned embodiments, and an arbitrary component in accordance with any one of the above-mentioned embodiments can be omitted within the scope of the invention.

### INDUSTRIAL APPLICABILITY

The PON system in accordance with the present invention does not need to newly make a change to the parameters and so on even if the topology map is changed, and can notify in which optical fiber cable 5 a fault has occurred at the time of occurrence of a link interruption of an ONU to outside the PON system. The PON system is suitable for use as a PON system or the like that estimates an optical fiber cable in which a fault has occurred at the time of occurrence of a link interruption, and makes a notification to outside the PON system as a warning.

### EXPLANATIONS OF REFERENCE NUMERALS

1 OLT,
2, 2a to 2g ONU,
3 PON-IF card,
4, 4a to 4e splitter,
5, 5a to 5l optical fiber cable,
11 topology map holder,
12 link interruption detector,
13 warning collector,
14 filter,
15 fault part estimator,
16 fault part notifier,
17 plural link interruption determinator,
18 under-identical-trunk determinator,
19 splitter normality determinator,
41 light emitter.

1. A PON system including an OLT connected to a plurality of ONUs via a plurality of splitters and optical fiber cables, wherein
said OLT comprises:
a topology map holder that holds a topology map of said PON system;
a link interruption detector that detects a link interruption in said ONUS;
a warning collector that collects warnings from said ONUS;
a filter that extracts a warning resulting from said ONUs from the warnings collected by said warning collector;
a fault part estimator that, when a link interruption of said ONUs is detected by said link interruption detector and there is no warning which is extracted by said filter, estimates in which of said optical fiber cables a fault has occurred on a basis of the topology map held by said topology map holder; and
a fault part notifier that notifies information showing the fault part estimated by said fault part estimator to outside said PON system.

2. The PON system according to claim 1, wherein said OLT comprises a plural link interruption determinator that determines whether or not link interruptions have been detected in a plurality of ones of said ONUs within a predetermined time period by said link interruption detector, and an under-identical-trunk determinator that, when said plural link interruption determinator determines that link interruptions have been detected in a plurality of ones of said ONUs within the predetermined time period, determines whether link interruptions have occurred in all ONUs serving under an identical one of said optical fiber cables on a basis of the topology map held by said topology map holder, and wherein said fault part estimator determines whether the link interruption of said ONUs results from either a fault of said optical fiber cables or a fault of said ONUs on a basis of a result of the determination by said plural link interruption determinator and a result of the determination by said under-identical-trunk determinator.

3. The PON system according to claim 1, wherein each of said splitters comprises a light emitter that emits light having a different wavelength toward said OLT, and said OLT comprises a splitter normality determinator that detects the light emitted by said light emitter, and performs determination of whether or not said splitter is normal, and wherein said fault part estimator determines whether the link interruption of said ONUs results from either a fault of a portion from said splitters to said OLT a fault of a portion from said splitters to said ONUs on a basis of a result of the determination by said splitter normality determinator.

4. An OLT connected to a plurality of ONUs via a plurality of splitters and optical fiber cables, said OLT comprising:
a topology map holder that holds a topology map of said PON system;
a link interruption detector that detects a link interruption of said ONUs;
a warning collector that collects warnings from said ONUs;
a filter that extracts a warning resulting from said ONUs from the warnings collected by said warning collector;
a fault part estimator that, when a link interruption of said ONUs is detected by said link interruption detector and there is no warning which is extracted by said filter, estimates in which of said optical fiber cables a fault has occurred on a basis of the topology map held by said topology map holder; and
a fault part notifier that notifies information showing the fault part estimated by said fault part estimator to outside said OLT.
